(19) United States
(12) Patent Application Publication
(10) Pub. No.: US 2014/0085177 A1
(43) Pub. Date: Mar. 27, 2014

(54) METHOD AND APPARATUS FOR RESPONDING TO INPUT BASED UPON RELATIVE FINGER POSITION

(71) Applicant: NOKIA CORPORATION, Espoo (FI)

(72) Inventors: Kenton M. Lyons, Santa Clara, CA (US); Ke-Yu Chen, Seattle, WA (US); Sean White, Mountain View, CA (US); Daniel L. Ashbrook, Sunnyvale, CA (US)

(73) Assignee: NOKIA CORPORATION, Espoo (FI)

(21) Appl. No.: 13/624,359

(22) Filed: Sep. 21, 2012

(51) Int. Cl. G06F 3/01

(52) U.S. Cl. 345/156

(57) ABSTRACT

A method, apparatus and computer program product are provided to facilitate user input based upon the relative position of their fingers. In the context of a method, sensor information is received that is indicative of the position of a first finger relative to a second finger. The first finger may be a thumb such that the sensor information is indicative of the position of the thumb relative to the second finger. In conjunction with the receipt of sensor information, the method receives sensor information from a sensor that is offset from an interface between the first and second fingers so as not to be positioned between the first and second fingers. The method also determines, with a processor, the relative position of the first and second fingers based upon the sensor information and causes performance of an operation in response to the relative position of the first and second fingers.

### TECHNOLOGICAL FIELD

An example embodiment of the present invention relates generally to the recognition of user input and, more particularly, to a method, apparatus and computer program product for recognizing and responding to user input based upon relative finger position.

### BACKGROUND

Users can provide input to a computing device in a variety of different manners. For example, users may provide input via a computer mouse, a touch pad, a touch screen, audible commands, e.g., voice commands, or the like. By way of example, a head mounted display, such as a pair of augmented reality glasses, may require user input to be provided based upon the user's touch or actuation of one or more buttons or sensors of the head mounted display. For example, the stems of a pair of augmented reality glasses may include one or more buttons or other sensors that may be actuated by a user in order to provide input.

The user input provided to a head mounted display via one or more buttons or sensors may not be intuitive for the user and may therefore require the user to focus upon user input operation and be distracted from other activities in which the user is engaged. Further, the provision of user input via one or more buttons or other sensor carried by a head mounted display may seem unnatural to others in the vicinity of the user and may draw unwanted attention to the user.

### BRIEF SUMMARY

A method, apparatus and computer program product are provided according to an example embodiment of the present invention in order to facilitate user input based upon relative position of a user's fingers. In particular, a method, apparatus and computer program product are provided in accordance with one embodiment in order to receive and recognize user input that is provided by the relative position of the user's fingers in a manner that is not distracting, either to the user or to other persons in the vicinity of the user. While the method, apparatus and computer program product of an example embodiment may be employed in conjunction with a variety of computing devices that are responsive to user input, a method, apparatus and computer program product of one embodiment may provide input to a head mounted display, such as a pair of augmented reality glasses, so as to permit a user to interact with the head mounted display while continuing to view their surroundings and without drawing unwanted attention to the user.

In one embodiment, a method is provided that includes receiving sensor information indicative of a position of a first finger relative to a second finger. In one embodiment, the first finger is a thumb such that the sensor information is indicative of the position of the thumb relative to the second finger. In conjunction with the receipt of sensor information, the method receives sensor information from a sensor that is offset from an interface between the first and second fingers so as not to be positioned between the first and second fingers. The method of this embodiment also determines, with a processor, the position of the first finger relative to the second fingerbased upon the sensor information and causes performance of an operation in response to the position of the first finger relative to the second finger.

The receipt of the sensor information may include receiving sensor information from a magnetometer carried by one of the first and second fingers indicative of the position of the magnetometer relative to a magnet carried by the other one of the first and second fingers. The method of this embodiment may also determine the position of the first finger relative to the second fingerby determining the position of the first finger relative to the second finger in at least one dimension. In another embodiment, the receipt of the sensor information may include receiving sensor information from first and second magnetometers carried by one of the first and second fingers indicative of the position of the first and second magnetometers relative to a magnet carried by the other one of the first and second fingers. In this embodiment, the determination of the position of the first finger relative to the second finger may include determining the position of the first finger relative to the second fingerin at least two dimensions. The first and second magnetometers of this embodiment may be carried by one of the first and second fingers so as to have a predefined offset therebetween.

The method of one embodiment may also include determining a direction of movement of the first finger across the second finger based upon the position of the first finger relative to the second finger at two or more instances. In this embodiment, the method may cause the performance of the operation by causing performance of the operation in response to the direction of movement of the first finger across the second finger. In another embodiment, the receipt of the sensor information may include receiving the sensor information from first and second magnetometers carried by the first and second fingers, respectively, indicative of the position of the first and second magnetometers within an electromagnetic field. In this embodiment, the determination of the position of the first finger relative to the second fingermay include determining the position of the first finger relative to the second fingerin at least two dimensions. In another embodiment, a textured surface is carried by at least one of the first and second sensors. In this embodiment, the receipt of the sensor information may include receiving sensor information from a vibration or acoustic sensor indicative of movement of one of the first and second fingers across a textured surface.

In another embodiment, an apparatus is provided that includes at least one processor and at least one memory including computer program code with the at least one memory and the computer program code configured to, with the processor, cause the apparatus to at least receive sensor information indicative of a position of a first finger relative to the second finger. In one embodiment, the first finger is a thumb such that the sensor information is indicative of the position of the thumb relative to the second finger. The sensor information is received from a sensor that is offset from an interface between the first and second fingers so that it is not positioned between the first and second fingers. The at least one memory and the computer program code are also configured to, with the processor, cause the apparatus to determine the position of the first finger relative to the second fingerbased upon the sensor information and to cause performance of an operation in response to the position of the first finger relative to the second finger.

The at least one memory and the computer program code are configured to, with the processor, cause the apparatus of one embodiment to receive the sensor information by receiving sensor information from a magnetometer carried by one of the first and second fingers indicative of the position of the magnetometer relative to the magnet carried by the other one of the first and second fingers. In this embodiment, the at least one memory and the computer program code are also configured to, with the processor, cause the apparatus to determine the position of the first finger relative to the second fingerby determining the position of the first finger relative to the second fingerin at least one dimension. The at least one memory and the computer program code are configured to, with the processor, cause the apparatus of another embodiment to receive the sensor information by receiving sensor information from first and second magnetometers carried by one of the first and second fingers indicative of the position of the first and second magnetometers relative to the magnet carried by the other one of the first and second fingers. In this embodiment, the at least one memory and the computer program code are configured to, with the processor, cause the apparatus to determine the position of the first finger relative to the second fingerby determining the position of the first finger relative to the second fingerin at least two dimensions. The first and second magnetometers may be carried by one of the first and second fingers so as to have a predefined offset therebetween.

The at least one memory and the computer program code are configured to, with the processor, cause the apparatus of one embodiment to determine a direction of movement of the first finger across the second finger based upon the position of the first finger relative to the second finger at two or more instances. In this embodiment, the at least one memory and the computer program code may be configured to, with the processor, cause the apparatus to cause performance of the operation by causing performance of the operation in response to the direction of movement of the first finger across the second finger. The at least one memory and the computer program code may be configured to, with the processor, cause the apparatus of another embodiment to receive the sensor information by receiving sensor information from first and second magnetometers carried by the first and second fingers, respectively, indicative of the position of the first and second magnetometers within an electromagnetic field. In this embodiment, the at least one memory and the computer program code are configured to, with the processor, cause the apparatus to determine the position of the first finger relative to the second fingerby determining the position of the first finger relative to the second fingerin at least two dimensions. In another embodiment, a textured surface is carried by at least one of the first and second fingers. In this embodiment, the at least one memory and the computer program code are configured to, with the processor, cause the apparatus to receive the sensor information by receiving sensor information from a vibration or acoustic sensor indicative of movement of one of the first and second fingers across the textured surface.

In a further embodiment, a computer program product including at least one non-transitory computer-readable storage medium having computer-executable program code portions stored therein is provided with the computer-executable program code portions including program code instructions for receiving sensor information indicative of a position of a first finger relative to a second finger. In one embodiment, the first finger is a thumb such that the sensor information is indicative of the position of the thumb relative to the second finger. The program code instructions for receiving the sensor information may include program code instructions for receiving sensor information from a sensor that is offset from the interface between the first and second fingers so as not to be positioned between the first and second fingers. The computer-executable program code portions also include program code instructions for determining the position of the first finger relative to the second finger based upon the sensor information and the program code instructions for causing performance of an operation in response to the position of the first finger relative to the second finger.

The program code instructions for receiving the sensor information may include program code instructions for receiving sensor information from at least one magnetometer carried by one of the first and second fingers indicative of the position of the at least one magnetometer relative to the magnet carried by the other one of the first and second fingers. In this embodiment, the program code instructions for determining the th position of the first finger relative to the second fingermay include program code instructions for determining the position of the first finger relative to the second fingerin at least one dimension. In another embodiment, a textured surface is carried by at least one of the first and second fingers. In this embodiment, the program code instructions for receiving the sensor information may include program code instructions for receiving sensor information from a vibration or acoustic sensor indicative of movement of one of the first and second fingers across the textured surface.

In yet another embodiment, an apparatus is provided that includes means for receiving sensor information indicative of a position of a first finger, such as a thumb, relative to a second finger. In this regard, the means for receiving sensor information may include means for receiving sensor information from a sensor that is offset from an interface between the first and second fingers so as not to be positioned between the first and second fingers. The apparatus of this embodiment also includes means for determining the position of the first finger relative to the second fingerbased upon the sensor information and means for causing performance of an operation in response to the position of the first finger relative to the second finger.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a flow chart illustrating operations performed, for example, by the apparatus of FIG. 1 in accordance with an example embodiment to the present invention;

FIG. 3 is a perspective view of a first finger that carries a magnetometer and a second finger that carries a magnet such that the relative positions of the first and second fingers, such as occasioned by movement of the first finger alongside the second finger while the second finger is in a bent configuration, may provide sensor information in accordance with an example embodiment of the present invention;

FIG. 4 is a perspective view of a first finger that carries a magnetometer and a second finger that carries a magnet such that the relative positions of the first and second fingers, such as occasioned by movement of the first finger alongside the second finger while the second finger is in a straight configuration, may provide sensor information in accordance with an example embodiment of the present invention;

FIG. 5 is a perspective view of a first finger that carries first and second magnetometers and a second finger that carries a magnet such that the relative positions of the first and second fingers, such as occasioned by movement of the first finger alongside the second finger while the second finger is in a bent configuration, may provide sensor information in accordance with an example embodiment of the present invention;

FIG. 6 illustrates first and second fingers that carry first and second magnetometers, respectively, for providing sensor information in response to the relative positions of the first and second fingers within an electromagnetic field created by one or more electromagnets carried, for example, by the user movement in accordance with an example embodiment of the present invention; and

FIG. 7 is a perspective view in which a textured surface is carried by one of the fingers and a vibration or acoustic sensor is configured to provide sensor information indicative of the movement of one of the first and second fingers across the textured surface in accordance with another example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided according to an example embodiment in order to receive and respond to user input provided on the basis of relative position and, in some embodiments, movement between two or more fingers of the user. The user input based upon the relative finger position may provide input for a variety of different computing devices. By way of example, but not of limitation, the user input based upon the relative position of the user's fingers may provide input to a head mounted display, such as a pair of augmented reality glasses in order to permit the user to interact with the head mounted display in a manner that does not obstruct the user's view of their surroundings and in a manner that does not attract undesired attention from others in the vicinity.

A head mounted display permits a user to optically view a scene external to the head mounted display. By way of example, a head mounted display may be in the form of a pair of glasses. The glasses may be worn by user such that the user may view a scene, e.g., a field of view, through the lenses of the glasses. However, the glasses may also be configured to present a visual representation of other information upon the lenses so as to augment or supplement the user's view of the scene through the lenses of the glasses. As such, the glasses may support augmented reality and other applications. While augmented reality glasses are one example of a head mounted display, a head mounted display may be embodied in a number of different manners with a variety of form factors, each of which may permit a user to optically see through the display so as to view the user's surroundings and each of which (along with a number of other types of computing devices) may benefit from the method, apparatus and computer program product of an example embodiment of the present invention as described below.

In one embodiment, an apparatus 10 may be provided in order to receive sensor information indicative of the relative position of the user's fingers and to cause performance of an operation in response to the relative position. In one embodiment, the apparatus may be embodied by the computing device to which the user is providing input via the relative position of their fingers. For example, a head mounted display, such as a pair of augmented reality glasses, may embody the apparatus of one embodiment so as to receive the sensor information indicative of the relative position of the user's fingers and to cause performance of an operation in response thereto. Alternatively, the apparatus may be embodied by a different computing device different than that for which the user is providing input based upon the relative position of their fingers. For example, a computing device, such as a portable digital assistant (PDAs), mobile telephone, smartphone, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems, may embody the apparatus of one embodiment so as to receive and process the sensor information indicative of the relative position of the user's fingers. In this embodiment, the computing device that embodies the apparatus may then provide direction to another computing device, such as a head mounted display, to which the user is providing input based upon the relative position of their fingers.

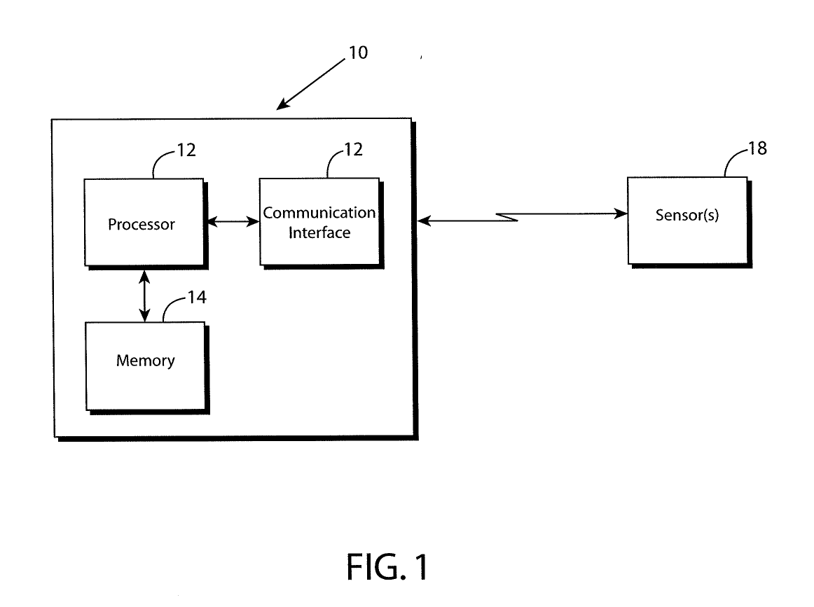

Referring now to FIG. 1, an apparatus 10 that may be embodied by a computing device for receiving and responding to user input may include or otherwise be in communication with a processor 12, a memory device 14 and a communication interface 16. It should be noted that while FIG. 1 illustrates one example of a configuration of an apparatus for receiving and responding to user input, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 12 (and/or co-processors or any other processing circuitry assisting or otherwise associated with the processor) may be in communication with the memory device 14 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 10 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 10 may be embodied by a computing device, such as a head mounted display or the like, configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 16 may be any means such as a device or circuitry embodied in either hardware or a combination of hardware and software that is configured to receive and/or transmit data from/to a network and/or any other device or module in communication with the apparatus 10. For example, the communication interface may be configured to communicate with one or more sensors 18 that provide the sensor information indicative of relative movement between the user's fingers. Additionally, the communication interface may be configured to communicate with other components of the computing device in an instance in which the apparatus is embodied by the computing device for which the user is providing input or with a remote computing device in an instance in which the apparatus is separate from the computing device for which the user is providing input.

In this regard, the communication interface 16 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface may be configured to communicate wirelessly with the sensor(s) 18, such as via Wi-Fi, Bluetooth or other wireless communications techniques. Likewise, the communications interface may be configured to communicate wirelessly with a remote computing device in an instance in which the apparatus is separate from the computing device for which the user is providing input.

In some environments, the communication interface 16 may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of a computing device in an instance in which the apparatus 10 is embodied by the computing device for which the user is providing input.

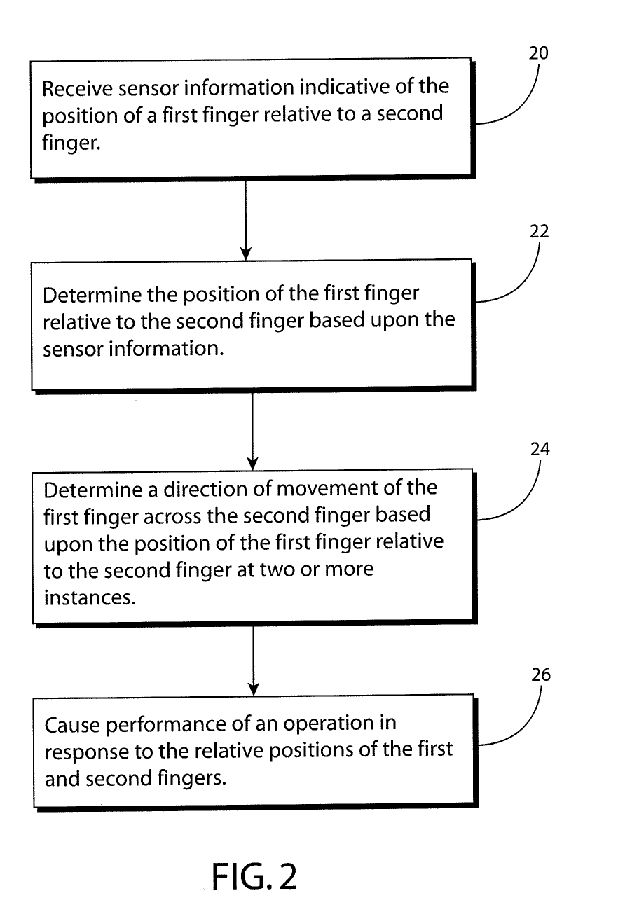

Referring now to FIG. 2, the operations performed, such as by the apparatus 10 of FIG. 1, in accordance with an example embodiment of the present invention are illustrated. As shown in block 20, sensor information is received that is indicative of the position of a first finger relative to the second finger. In this regard, the apparatus may include means, such as communication interface 16, the processor 12 or the like, for receiving sensor information indicative of the relative position of the user's fingers. Although the sensor information may be received in various manners, the sensor information of one embodiment is received from a sensor 18 via a wireless communication technique. Various types of sensors may be employed in order to provide the sensor information that is indicative of the relative position of the user's fingers.

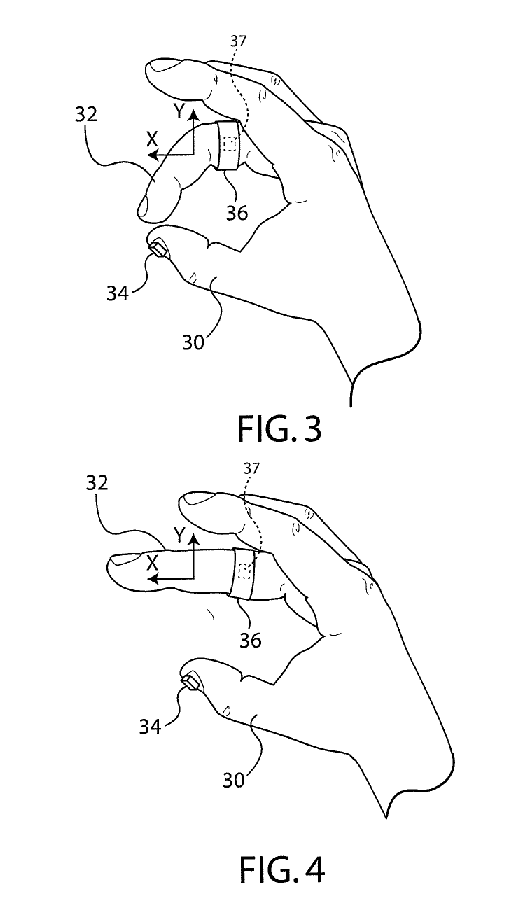

With reference to FIG. 3, the relative position of the user's fingers may be determined based upon the interaction of a magnet 37 carried by one of the user's fingers and one or more magnetometers carried by another one of the user's fingers. In one embodiment, a first magnetometer 34 may be carried by the user's thumb 30 and a permanent magnet may be carried by another one of the user's fingers 32, such as the user's middle finger, the user's forefinger or the like.

With respect to the magnetometer 34, the magnetometer may be carried by the user's finger, such as the user's thumb 30, in various manners, but, in one embodiment, the first magnetometer is mounted upon and carried by the back side or side surface of the user's finger so as not to obstruct the pad of the user's finger that may be utilized for other purposes. For example, a first magnetometer may be mounted upon the thumbnail of the user's thumb. The first magnetometer may be mounted upon the thumbnail in various manners including temporarily adhering the first magnetometer to the user's thumbnail or incorporating the first magnetometer into a ring that is mounted upon or worn by the user's thumb such that the first magnetometer overlies the user's thumbnail.

As noted above, a magnet 37, such as a permanent magnet, may be carried by another one of the user's fingers 32. While the magnet may be carried by another one of the user's fingers in various manners, the magnet of one embodiment may be included within or carried by a ring 36 that is worn by the user on the other finger. In this embodiment, the ring may be configured so as to be mounted upon the user's other finger in a manner that causes the magnet to be maintained in a predefined orientation with respect to the user's other finger. In this regard, the magnet may be carried by the user's other finger so as to be positioned along the side of the user's other finger such that the north and south poles of the magnet have a predefined position and orientation relative to the user's other finger.

As a result of the interaction of the magnet 37 and the magnetometer 31 carried by the user's fingers, sensor information indicative of the relative position of the user's fingers may be provided to the apparatus 10. In an instance in which the sensor information is provided by a single magnetometer based upon the position of the single magnetometer carried by one of the user's fingers relative to a magnet carried by another one of the user's fingers, the magnetometer may provide sensor information indicative of the distance between the magnetometer and the magnet. Various types of sensor information may be provided by the magnetometer including, for example, sensor information that indicates the strength of the magnetic field established by the magnet at the current location of the magnetometer, such that the apparatus, such as the processor 12, may determine the distance between the magnetometer and the magnet.

In order to provide a context for the relative position and, in some embodiments, movement between the user's fingers, the user's fingers may be positioned in a predefined manner. As shown in FIG. 3, for example, the finger 32 carrying the magnet 37 may be positioned in a bent configuration. In this regard, the bent configuration the finger may define a reference plane with the bent finger lying within the resulting plane. Thus, position of the other finger, such as the thumb 30, that carries the magnetometer 34 relative to the finger that carries the magnet, such as occasioned by moving the thumb relative to the side surface of the finger that carries the magnet, e.g., by rubbing the pad of the thumb across the side surface of the middle finger, may serve as the input. In an instance in which the thumb carries a single magnetometer, the position of the thumb relative to the middle finger that carries a magnet may cause sensor information to be provided by the magnetometer indicative of the distance between the magnetometer and the magnet, such as the distance within the plane defined by the bent configuration of the finger that carries the magnet. By considering the sensor information provided by the magnetometer over the course of time, such as at two or more instances in time, the movement of the thumb relative to the finger that carries the magnet may be determined as a result of changes in the distance between the magnetometer and the magnet.

In another embodiment depicted in FIG. 4, the finger 32 that carries the magnet 37 may be extended so as to have a straight or extended configuration. In this embodiment, the finger that carries the magnetometer 34, such as the thumb 30, may be slid lengthwise along the side of the finger that carries the magnet such that the extended configuration of the finger that carries the magnet defines an axis along which the relative position, e.g., the distance between, the magnetometer carried by the thumb and the magnet carried by the extended finger may be defined.

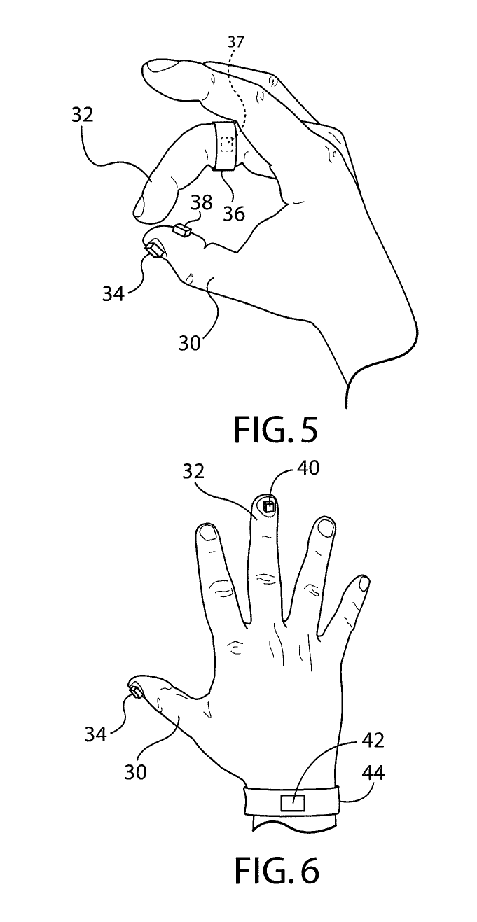

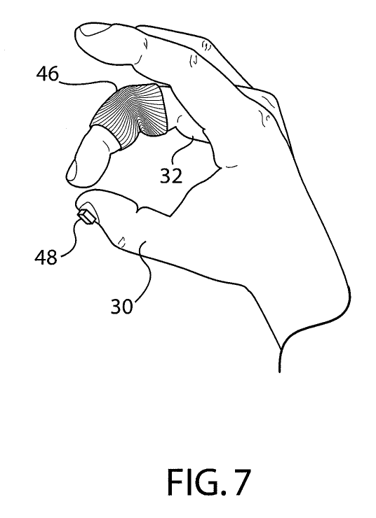

As noted above, the user's finger, such as the thumb 30, may carry one or more magnetometers. In the embodiment depicted in FIG. 5, for example, the user's thumb carries first and second magnetometers 34, 38. In one embodiment, the first and second magnetometers are offset from one another, such as by having a predefined offset therebetween. Although the first and second magnetometers may be offset in various manners, the first and second magnetometers may be carried by the user's finger, such as the thumb, so as to have different orientations. For example, the first magnetometer may be carried by the back surface of the thumb, such as by being mounted upon the thumbnail, while the second magnetometer may be carried by a side surface of the thumb. As noted above, the first and second magnetometers may be carried by the thumb in various manners, such as by being adhered to the thumb or by being incorporated within or carried by a ring that is slid upon the thumb and maintained thereon in a predefined orientation.

In this embodiment, the first and second magnetometers 34, 38 interact with the magnet 37 carried by another finger 32 of the user such that the relative position between the user's fingers may be determined in at least two dimensions, such as in three dimensions in one embodiment. As described above, the finger that carries the magnet may be positioned so as to define a reference plane within which relative position of the first and second magnetometers with respect to the magnet is determined. For example, in the embodiment of FIG. 5, the finger that carries the magnet may have a bent configuration so as to define a plane within which the bent finger lies. In this embodiment, mutually orthogonal axes, such as X and Y axes, may be defined in the plane defined by the bent configuration of the finger that carries the magnet. For example, one dimension, e.g., the y direction, may be defined across the side surface of the finger that carries the magnet, such as from an inside surface of the finger to an exterior surface of the finger at the location of the middle knuckle, with the other dimension, e.g., the x direction, being defined orthogonal thereto. See FIG. 3. Alternatively, the finger that carries the magnet may have a straight configuration with one dimension, e.g., the x direction, defined along the length of the straightened finger and the other dimension, e.g., the y direction, being defined orthogonal thereto in a direction across the side surface of the straightened finger. See FIG. 4. The relative position of the first finger, such as the thumb, with respect to the second finger that carries the magnet may then be detected by the first and second magnetometers and provided to the apparatus 10 such that the position of the first finger relative to the second finger may be determined in at least two dimensions.

In another embodiment, the user's finger, such as the thumb 30, may carry three or more magnetometers with the magnetometers being offset from one another. For example, the user's thumb may carry three magnetometers with a predefined offset between each of the three magnetometers. By way of example, the first magnetometer may be carried by a thumbnail, while the second and third magnetometers are carried by opposite side surfaces of the user's thumb. While the magnetometers may be adhered to the user's thumb, the magnetometers of another embodiment may be incorporated within or carried by a ring that is mounted upon the user's finger, such as the user's thumb. Based upon the position of the user's finger, such as the thumb, relative to the user's other finger that carries the magnet 37, the first, second and third magnetometers of this embodiment may provide sensor information to the apparatus 10 that is representative of the position of the respective magnetometer relative to the magnet. Based upon the sensor information provided by the first, second and third magnetometers of this embodiment, the apparatus, such as the processor 12, of one embodiment may determine the direction of the movement of the user's finger that carries the magnetometers across the finger that carries the magnet in at least three dimensions.

In order to avoid unintended user input, a trigger may be incorporated by one embodiment to provide an indication that the sensor information that will thereafter be provided will be indicative of the relative position of the user's fingers and is intended to serve as user input. For example, the user may trigger operation of the method of one embodiment by performing a predefined action, such as by holding a first magnetometer 34 in contact with or within a predefined distance of the magnet 37 for a predefined period of time. Alternatively, a secondary sensor may be provided to detect acoustic or capacitive coupling between the first magnetometer and the magnet, which may serve as the trigger. Prior to the trigger, any sensor information that may be provided may be disregarded by the apparatus 10 so as to avoid inadvertent or unintended user input. However, following receipt of an indication of the trigger signal, sensor information provided by the sensors 18 should be analyzed by the apparatus, such as the processor 12, in order to determine the relative position of the user's fingers and to cause performance of an operation in response to the relative position of the user's fingers.

Returning to block 20 of FIG. 2, the apparatus 10, such as the communications interface 16, the processor 12 or the like, may be configured to receive the sensor information indicative of the position of the first finger, such as the user's thumb 30, relative eto a second finger 32. As described above in conjunction with embodiments in which the first finger carries one or more magnetometers, the sensor information provided by the magnetometers may be indicative of the distance of each magnetometer from the magnet carried by the second finger. As shown in block 22 of FIG. 2, the apparatus may include means, such as the processor or the like, for determining the position of the first finger relative to the second finger based upon the sensor information. For example, the sensor information that is received may represent or otherwise define the relative position of the first and second fingers such that the apparatus, such as the processor, may determine the relative position by recognizing and interpreting as the relative position of the first and second fingers. Alternatively, the sensor information may be representative of the strength of the magnetic field at the location of each magnetometer such that the apparatus and, more particularly, the processor, may convert the sensor information representative of the strength of the magnetic field into the relative position of the first and second fingers.

As shown in block 24, the apparatus 10 of one embodiment may also include means, such as the processor 12 or the like, for determining a direction of movement of the first finger across the second finger based on the position of the first finger relative to the second finger at two or more instances. In this regard, the sensor information that is received at any one instant in time may be representative of the current position of each magnetometer with respect to the magnet. As such, the apparatus, such as the processor, may consider sensor information provided over the course of time such that the change in the position of each magnetometer with respect to the magnet may be determined, thereby defining the movement of the magnetometer(s) with respect to the magnet and, in turn, the direction of movement of the user's finger that carries the magnetometer(s) to the user's finger that carries the magnet.

In an embodiment in which the sensor information is provided by a single magnetometer 34 carried by the first finger, the apparatus 10, such as the processor 12, may determine the direction of the movement in at least one dimension. However, in an embodiment in which first and second magnetometers 34, 38 are carried by the first finger, the apparatus, such as the processor, may determine the direction and movement in at least two dimensions, such as in three dimensions. Further, in an instance in which first, second and third magnetometers are carried by the first finger, the apparatus, such as the processor, may determine the direction of movement in at least three dimensions.

The determination of the relative position of the user's fingers by the apparatus 10, such as the processor 12, may be facilitated by the predefined offset between the magnetometers in an instance in which two or more magnetometers are carried by the first finger 30. Further, the position of the first finger, such as the user's thumb, relative to the user's second finger 32 that carries the magnet 37 and that is configured in a predefined configuration, such as a bent configuration, a straightened configuration or the like, may also facilitate the determination of the relative position of the user's fingers.

By way of example, in an embodiment in which a magnet 37 is carried by the user's second finger, such as the user's middle finger 32, and first and second magnetometers 34, 38 are carried by the user's first finger, such as the user's thumb 30, the magnet creates a two-dimensional polar coordinate system that is sensed by the first and second magnetometers. Each magnetometer may generate a reading representative of its location with respect to the magnet that may be represented as [Ha, Hb, Hc]. The readings of the first and second magnetometers may be provided, in one embodiment, to the apparatus 10 such that the apparatus, e.g., the processor 12, may then rotate the readings provided by the first and second magnetometers by a transformation matrix T such that [Ha, Hb, Hc]=T*[Hr, Ht, 0] with Hr being the strength of the magnetic field in the radial direction and Ht being the strength of the magnetic field in the tangential direction. As a result of the predefined offset between the first and second magnetometers of one embodiment, there will only be a single transformation matrix, or a small range of transformation matrices, that provides a solution. The apparatus, such as the processor, may then be configured to transform the readings of the first and second magnetometers into a corresponding radius R value and angle θ value with Hr=(M/2*π*R³)*cos (θ) and Ht=(M/4*π*R³)*sin (θ). The apparatus, such as the processor, may then transform the radius and angle values into corresponding X and Y values utilizing conventional trigonometric relationships. By determining the position of the first and second magnetometers of this embodiment as defined by the X and Y values corresponding to the magnetometer readings that are provided at two or more instances, the relative movement of the first and second magnetometers with respect to the magnet carried by another finger of the user and, as such, the direction of the movement of the user's finger, such as the user's thumb, that carries the first and second magnetometers with respect to the user's finger that carries the magnet may be determined. In addition to providing an indication as to the position of the user's finger, such as the user's thumb, that carries the first and second magnetometers with respect to the user's finger that carries the magnet, the magnetometer readings provided by the first and second magnetometers to the apparatus may also permit the apparatus, such as the processor, to determine the orientation of the user's thumb, such as by estimating the pitch, roll and yaw of the user's thumb.

In the foregoing embodiments, one or more magnetometers were carried by one of the user's fingers, such as the user's thumb 30, and a magnet 37 was carried by another one of the user's fingers 32. However, the fingers that carry the magnetometers and the magnet may be reversed with the magnet carried by the user's thumb and one or more magnetometer being carried by the user's other finger(s), such as the user's middle finger, the user's forefinger or the like. Additionally, magnetometers may be carried by more than one finger of the user with readings provided by each of the magnetometers. In response, the apparatus 10, such as the processor 12, may be configured to determine the respective position of each of the fingers that carry one or more magnetometers with respect to the finger that carries the magnet, thereby permitting more complex user inputs to be provided.

In yet another embodiment that is illustrated in FIG. 6, one or more magnetometers may be carried by each of two or more fingers of the user. For example, one or more first magnetometers 34 may be carried by a first finger 30 and one or more second magnetometers 40 may be carried by a second finger 32. In this embodiment, one or more electromagnets 42 are also provided for creating an electromagnetic field such that the position and, in some embodiments, the movement of the magnetometers within the electromagnetic field may be tracked. In one embodiment, at least one electromagnet, such as three orthogonally positioned electromagnets, may be carried by the user, such as by being carried by or included within a bracelet 44 worn by the user. By sequentially actuating each electromagnet such that a corresponding electromagnetic field is generated, magnetometer readings generated by the magnetometers carried by the first and second fingers may be provided to the apparatus 10 such that the apparatus, such as the processor 12, may determine the relative positions of the first and second fingers that carry the magnetometers within the electromagnetic field. Indeed, the magnetometer readings provided as a result of the movement of the magnetometer(s) through the electromagnetic field may define the location of the user's fingers that carry the magnetometers in each of their six degrees of freedom, e.g., x, y, z, pitch, roll and yaw.

Although the magnetometers have served as the sensor(s) 18 in the foregoing embodiments, other types of sensors may be utilized to provide the sensor information from which a direction of movement of the user's first and second fingers may be determined. By way of example, a textured surface 46 may be carried by one of the first and second fingers. For example, a sleeve having a textured surface may be slid upon one of the user's fingers 32. Alternatively, a textured surface may be adhered to one of the user's fingers. Regardless, the textured surface has a texture that varies or differs in different directions, such as in the X and Y directions and/or in a radial direction from the center of the textured surface to a peripheral edge of the textured surface. In this embodiment, a user may provide input by rubbing one of their fingers across the textured surface carried by another one of their fingers. As a result of the variations in the texture, the movement of the user's finger across the textured surface generates different vibrations or sounds depending upon the type of texture with which the user's finger is in contact.

A vibration or acoustic sensor 48 may be positioned in proximity to the user's hand, such as by being carried by the user's hand, such as by being adhered to the user's thumbnail or being in the form of a ring, a bracelet or the like. The vibration or acoustic sensor may be configured to receive the vibration or acoustical signals generated by movement of one of the user's fingers across the textured surface carried by another one of the user's fingers. The sensor information that is provided by the vibration or acoustic sensor to the apparatus 10 may be analyzed such that the apparatus, such as the processor 12, may determine the direction of movement of the user's finger across the texture surface based upon variations in the vibrations or sounds occasioned by the different types of texture with which the user's finger makes contact as it is slid across the textured surface.

Referring now to block 26 of FIG. 2, the apparatus 10 includes means, such as the processor 12 or the like, for causing the performance of an operation in response to the position of the first finger relative to the second finger and, in one embodiment, in response to the direction of movement of the first finger across the second finger. The apparatus, such as the processor, may cause the performance of a wide variety of different operations depending upon the context in which the user input is being provided and the computing device that is responsive to the user input. In one embodiment in which a user is providing input to a head mounted display, such as a pair of augmented reality glasses, the movement of the user's first and second fingers may cause a cursor to be repositioned, a menu item to be selected or another action to be taken, such as by obtaining more detailed information regarding a selected item, causing a video clip to play or the like.

As such, a user may provide input via the method, apparatus and computer program product of an example embodiment of the present invention in a manner that is not obtrusive to the user and that does not draw undesired attention from others in the proximity of the user. Although several different sensors 18 have been described in regards to the provision of the sensor information that is analyzed by the apparatus 10, the sensors that provide the sensor information are offset from an interface between the first and second fingers so as not to be positioned between the first and second fingers. In this regard, the first and second fingers may carry magnetometers, magnets, acoustic surfaces, vibration or acoustic sensors or the like to collect sensor information indicative of the relative movement of the first and second fingers, but the sensors are not positioned between the first and second fingers and are instead, offset therefrom, such as by being carried by the back side of the finger, the side surfaces of the fingers or the like. As such, the user may utilize their hand in a conventional fashion even as the user provides input based upon the relative movement of two or more of the user's fingers.

As described above, FIG. 2 illustrates a flowchart of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving sensor information indicative of a position of a first finger relative to a second finger, wherein receiving sensor information comprises receiving sensor information from a sensor that is offset from an interface between the first and second fingers so as not to be positioned between the first and second fingers;
determining, with a processor, the position of the first finger relative to the second finger based upon the sensor information; and
causing performance of an operation in response to the position of the first finger relative to the second finger.

2. A method according to claim 1 wherein the first finger is a thumb such that the sensor information is indicative of the position of the thumb relative to the second finger.

3. A method according to claim 1 wherein receiving the sensor information comprises receiving sensor information from a magnetometer carried by one of the first and second fingers indicative of the position of the magnetometer relative to a magnet carried by the other one of the first and second fingers, and wherein determining the position of the first finger relative to the second finger comprises determining the position of the first finger relative to the second finger in at least one dimension.

4. A method according to claim 1 wherein receiving the sensor information comprises receiving sensor information from first and second magnetometers carried by one of the first and second fingers indicative of the position of the first and second magnetometers relative to a magnet carried by the other one of the first and second fingers, and wherein determining the position of the first finger relative to the second finger comprises determining the position of the first finger relative to the second finger in at least two dimensions.

5. A method according to claim 4 wherein the first and second magnetometers are carried by one of the first and second fingers so as to have a predefined offset therebetween.

6. A method according to claim 1 further comprising determining a direction of movement of the first finger across the second finger based upon the position of the first finger relative to the second finger at two or more instances, and wherein causing performance of the operation comprises causing performance of the operation in response to the direction of movement of the first finger across the second finger.

7. A method according to claim 1 wherein receiving the sensor information comprises receiving sensor information from first and second magnetometers carried by the first and second fingers, respectively, indicative of the position of the first and second magnetometers within an electromagnetic field, and wherein determining the position of the first finger relative to the second finger comprises determining the position of the first finger relative to the second fingerin at least two dimensions.

8. A method according to claim 1 wherein a textured surface is carried by at least one of the first and second fingers, and wherein receiving the sensor information comprises receiving sensor information from a vibration or acoustic sensor indicative of movement of one of the first and second fingers across the textured surface.

9. An apparatus comprising at least one processor and at least one memory including computer program code, the at least one memory and the computer program code configured to, with the processor, cause the apparatus to at least:
receive sensor information indicative of a position of a first finger relative to a second finger by receiving sensor information from a sensor that is offset from an interface between the first and second fingers so as not to be positioned between the first and second fingers;
determine a position of the first finger relative to the second fingerbased upon the sensor information; and
cause performance of an operation in response to the position of the first finger relative to the second finger.

10. An apparatus according to claim 9 wherein the first finger is a thumb such that the sensor information is indicative of the position of the thumb relative to the second finger.

11. An apparatus according to claim 9 wherein the at least one memory and the computer program code are configured to, with the processor, cause the apparatus to receive the sensor information by receiving sensor information from a magnetometer carried by one of the first and second fingers indicative of the position of the magnetometer relative to a magnet carried by the other one of the first and second fingers, and wherein the at least one memory and the computer program code are configured to, with the processor, cause the apparatus to determine the position of the first finger relative to the second fingerby determining the position of the first finger relative to the second fingerin at least one dimension.

12. An apparatus according to claim 9 wherein the at least one memory and the computer program code are configured to, with the processor, cause the apparatus to receive the sensor information by receiving sensor information from first and second magnetometers carried by one of the first and second fingers indicative of the position of the first and second magnetometers relative to a magnet carried by the other one of the first and second fingers, and wherein the at least one memory and the computer program code are configured to, with the processor, cause the apparatus to determine the position of the first finger relative to the second fingerby determining the position of the first finger relative to the second finger in at least two dimensions.

13. An apparatus according to claim 12 wherein the first and second magnetometers are carried by one of the first and second fingers so as to have a predefined offset therebetween.

14. An apparatus according to claim 9 wherein the at least one memory and the computer program code are further configured to, with the processor, cause the apparatus to determine a direction of movement of the first finger across the second finger based upon the position of the first finger relative to the second finger at two or more instances, and wherein the at least one memory and the computer program code are configured to, with the processor, cause the apparatus to cause performance of the operation by causing performance of the operation in response to the direction of movement of the first finger across the second finger.

15. An apparatus according to claim 9 wherein the at least one memory and the computer program code are configured to, with the processor, cause the apparatus to receive the sensor information by receiving sensor information from first and second magnetometers carried by the first and second fingers, respectively, indicative of the position of the first and second magnetometers within an electromagnetic field, and wherein the at least one memory and the computer program code are configured to, with the processor, cause the apparatus to determine the position of the first finger relative to the second fingerby determining the position of the first finger relative to the second fingerin at least two dimensions.

16. An apparatus according to claim 9 wherein a textured surface is carried by at least one of the first and second fingers, and wherein the at least one memory and the computer program code are configured to, with the processor, cause the apparatus to receive the sensor information by receiving sensor information from a vibration or acoustic sensor indicative of movement of one of the first and second fingers across the textured surface.

17. A computer program product comprising at least one non-transitory computer-readable storage medium having computer-executable program code portions stored therein, the computer-executable program code portions comprising program code instructions for:
receiving sensor information indicative of a position of a first finger relative to a second finger, wherein receiving sensor information comprises receiving sensor information from a sensor that is offset from an interface between the first and second fingers so as not to be positioned between the first and second fingers;
determining the position of the first finger relative to the second fingerbased upon the sensor information; and
causing performance of an operation in response to the position of the first finger relative to the second finger.

18. A computer program product according to claim 17 wherein the first finger is a thumb such that the sensor information is indicative of the position of the thumb relative to the second finger.

19. A computer program product according to claim 17 wherein the program code instructions for receiving the sensor information comprise program code instructions for receiving sensor information from at least one magnetometer carried by one of the first and second fingers indicative of the position of the at least one magnetometer relative to a magnet carried by the other one of the first and second fingers, and wherein the program code instructions for determining the position of the first finger relative to the second fingercomprise program code instructions for determining the position of the first finger relative to the second fingerin at least one dimension.

20. A computer program product according to claim 17 wherein a textured surface is carried by at least one of the first and second fingers, and wherein the program code instructions for receiving the sensor information comprise program code instructions receiving sensor information from a vibration or acoustic sensor indicative of movement of one of the first and second fingers across the textured surface.
